(19) United States
(12) Patent Application Publication
(10) Pub. No.: US 2003/0054833 A1
(43) Pub. Date: Mar. 20, 2003

(54) Application execution method and apparatus

(75) Inventor: Matthew A. Hayduk, Calgary (CA)

Correspondence Address: Schwegman, Lundberg, Woessner & Kluth, P.A., P.O. Box 2938, Minneapolis, MN, 55402, US

(73) Assignee: Intel Corporation

(21) Appl. No.: 09/955,510

(22) Filed: Sep. 18, 2001

(51) Int. Cl. H04Q 7/20

(52) U.S. Cl. 455/456; 455/458

(57) ABSTRACT

A system, apparatus, and method for executing an application are disclosed. The system includes a mobile element having user service preferences whose position is monitored by a position monitoring module, a service broadcaster which broadcasts service preferences and related applications to the mobile element, and a comparator coupled to the mobile element to compare the broadcast service preferences to the user service preferences.

### BACKGROUND INFORMATION

Telecommunications service providers constantly search for new revenue opportunities by taking advantage of unused bandwidth to broadcast information of possible interest to users, coupled with further information regarding advertising sponsors. Next generation mobile clients, such as cellular phones and wireless personal digital assistants (PDAs), providing enhanced application execution subsystems (e.g., additional memory, faster processors, and improved display capability) will support the use of increasingly informative and appealing information displays. For example, a movie theater may advertise portions of shows currently playing, along with available concession items that can be purchased on-line, or hotels may advertise the availability of rooms, including video tours. Such information is often made available in the form of increasingly complex software applications designed for downloading and execution by the mobile client.

Unfortunately, mobile client devices are usually constrained by limited resources. A particular client may not be able to support downloading and execution of every application available from various businesses. In addition, the information may not be useful unless it is of particular interest to the user, and/or located within some sort of proximity to the user. Finally, previously-loaded applications may only require information updates, instead of reloading the entire application prior to execution. For these reasons, broadcast and reception of each available application to a particular client is not an efficient use of communication bandwidth.

Thus, there is a need in the art to provide applications for execution by mobile clients based on information related to each client, such as user preferences, client position, and the existence of previously-loaded applications. The provision of applications should minimize the amount of client storage required, efficiently utilize available bandwidth, so as to maximize the use of position location capabilities within the relevant network and the concomitant opportunities for broadcasting useful information to users of mobile elements.

### BRIEF DESCRIPTION OF THE DRAWINGS

FIG. 1 is a schematic block diagram of a system according to the present invention;

FIG. 2 is a block diagram representation of a mobile element according to the present invention;

FIG. 3 is an exemplary tabular listing of various types of information which may be provided to a mobile element according to the present invention; and

FIG. 4 is a flowchart of one embodiment of a method of executing an application according to the present invention.

### DESCRIPTION OF THE PREFERRED EMBODIMENTS

In the following detailed description of the invention, reference is made to the accompanying drawings which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to practice the invention. Other embodiments may be utilized and derived therefrom, such that structural, logical, and electrical circuit substitutions and changes may be made without departing from the scope of the invention. The following detailed description, therefore, is not to be taken in a limiting sense, and the scope of the invention is defined only by the appended claims, along with the full range of equivalents to which such claims are entitled.

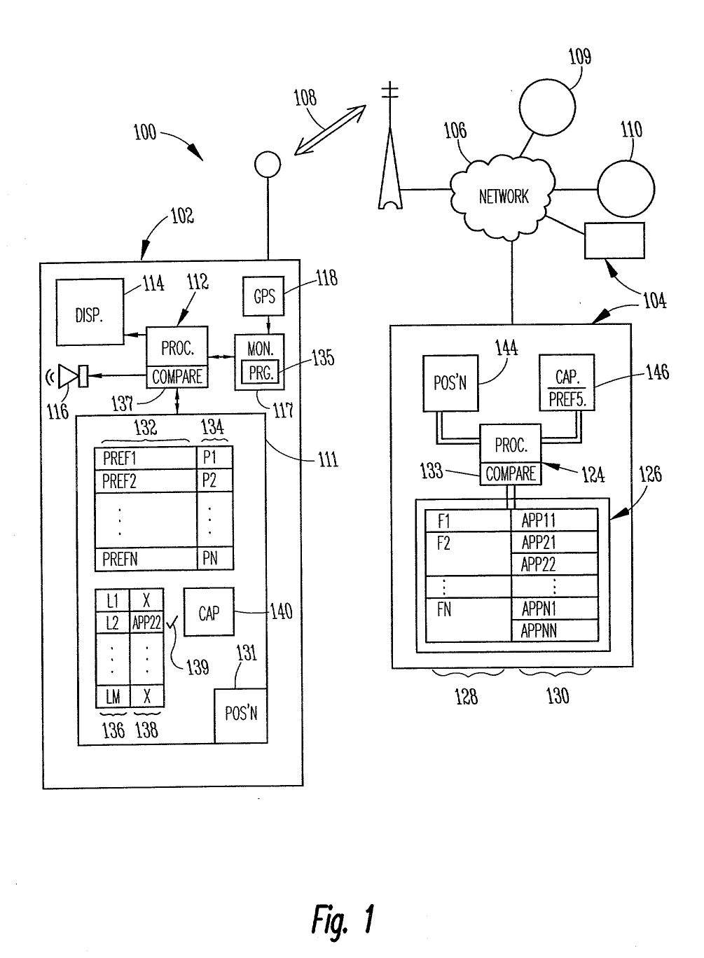

FIG. 1 is a schematic block diagram of an application execution system according to an embodiment of the present invention. The system 100 may include a mobile element 102 (typically operating as a mobile client, for example) and a service broadcaster 104 (typically operating as a server), which may be communicatively coupled over a wide area network (WAN) 106, such as a global telecommunications network, including the Internet, or a cellular wide area network (WAN) including an air interface 108. Businesses 109, 110 may also be communicatively coupled to the network 106.

The mobile element 102, which may be a cellular telephone, a wireless personal digital assistant (PDA), a personal internet client, a two-way pager, etc., typically includes a memory 111 communicating with a processor 112, and a display 114, as well as a sound output device 116, such as a speaker or speaker/microphone combination. For advertising purposes, the display 114 may be a high-resolution color display, and the sound output device 116 may be a multi-channel, high-fidelity device, such as stereo speakers or headphones. The processor 112, in turn, is typically communicatively coupled to a position monitoring module 117, which may in turn be communicatively coupled to a global positioning system (GPS) receiver 118.

The service broadcaster 104 typically includes a processor 124, as well as a memory 126 in which is stored a plurality of possible user preferences, or business data files 128, the various files being designated as F1 . . . FN. Each file is, in turn, associated with one or more applications 130 (APP11 . . . APPNN). For example, file F1 is associated with application APP11, file F2 is associated with applications APP21 and APP22, and file FN is associated with applications APPN1 . . . APPNN. The service broadcaster 104 is capable of broadcasting the files 128 and the applications 130 to the mobile element 104. The files 128 and associated applications 130 may be provided to the broadcaster 104 by a group of local businesses 109, 110 which seek to advertise their goods and services to various users of mobile elements 102, for example.

The mobile element 102 is typically associated with a position 131, capable of being monitored by the position monitoring module 117, and stored in the memory 111 of the mobile element 102. As will be discussed in more detail below, the position 131 may be any one of several indicators of the mobile element 102 location, such as a cellular operator zone, a set of geographic coordinates, a street address, etc.

A set of user service preferences 132 (PREF1, PREF2 . . . PREFN) is also typically included in the memory 111, along with associated priorities 134 (P1, P2 . . . PN). The preferences are typically classified according to businesses, services, or information types, such as movie theatres, weather, airlines, auto retailers, headline sports, taxi services, car rental, hotels, city transportation, police, restaurants, medical/dental services, convenience/specialty stores, maps, and virtually any consumer business that advertises its services.

As the mobile element 102 roams within the network 106, the position of the mobile element is monitored by the position monitoring module 117, typically using an included program module 135. The position may be transmitted to the broadcaster 104, either periodically, upon request, or continuously. The list of preferences 132, along with priorities 134, if desired, may also be sent to the broadcaster 104, or retained in the memory of the mobile element 102 and used as a filter (by the comparator module 137) against incoming data received from the broadcaster 104. In either case, the broadcaster 104 may transmit one or more of the files 128 to the mobile element 102 based on the current position 131 of the mobile element 102. If the client preferences 132 have previously been received by the broadcaster 104, then the files broadcast to the mobile element 102 may be filtered by the broadcaster 104 in accordance with the preferences received from the mobile element 102. In this case, a comparator module 133 residing in the broadcaster 104 may conduct the filtering operation. Otherwise, all of the files 128 may be broadcast to the mobile element 102, such that only those files which are related to the items in the preference list 132 may be retained in the memory 111 (L1, L2 . . . LM).

The related preferences or list files 136 (L1, L2 . . . LM), which are a subset of the preferences or files 128 maintained by the broadcaster 104 may then be examined manually by the user to determine whether further information is desired in the form of an associated application. Alternatively, the preferences or list files 136 may be analyzed using the comparator module 137 communicatively coupled to the memory 111. In either case, if a match 139 arises because it is determined that one or more of the preferences 132 and one or more of the received list files 136 are related (as determined by the comparator module 137 or the user of the mobile element 102), an application APP22 associated with the matching preference or list file L2, which may be identical to the file F2, for example, can be broadcast and downloaded to the mobile element 102 by the broadcaster 104.

The downloading activity may be initiated by the client automatically, as requested by the comparator module 137 after a related match 139 is determined, or in response to a manual selection/match 139 made when one or more of the preferences 132 and one or more of the received list files 136 are determined to be related by the user of the mobile element 102. As a further example, the comparator module 137 may be instructed to filter out any received restaurant information files which pertain to businesses that require reservations. Thus, only those applications associated with restaurants which do not require reservations may be selected for automatic download by the comparator module 137.

Of course, several associated applications 138 may be downloaded to the mobile element 102 by one or more broadcasters 104 over time. After the application APP22 associated with preference file F2 is downloaded to the mobile element 102, it is typically executed by the processor 112. After execution, the application APP22 may be retained for future use, and updated with new data when appropriate. Alternatively, if the application APP22 has a relatively low priority, as determined by the priorities 134, the application APP22 may be removed prior to downloading another application with a higher priority (which requires use of the same memory space).

A further refinement to the operation of the system 100 includes the concept of storing a list of mobile element performance capabilities 140 in the memory 111, and sending them to the broadcaster 104, either upon request, or automatically. Alternatively, the list of capabilities 140 can simply be retained in the memory 111 for comparison against those capabilities required to execute various applications associated with the list files 136.

For example, if the application APP22 associated with the list file L2 requires a color display with the ability to display at least 256 colors, this information may be included in the list L2. Then, prior to requesting that the application APP22 be downloaded to the mobile element 102, a comparison can be made against the list of actual capabilities 140 of the mobile element 102. If the capabilities list 140 indicates that the mobile element display 114 can accommodate up to 1024 colors, for example, then the application APP22 will be requested for downloading. If the display only provides 16 colors, then the application will not be broadcast for downloading, no application will be downloaded, and a message to this effect may be sent to the display 114 to inform the user. If desired, a similar message may be sent to the broadcaster 104 by the mobile element 102. This type of feedback is useful to inform the user when the mobile element 102 is not able to accommodate various applications, as well as to inform various businesses 109, 110 offering those applications that the public is not receiving the advertising that is being purchased.

Thus, the broadcaster 104 not only serves the purpose of disseminating information efficiently, but may also be used to gather consumer information. For example, the position of the mobile element 102 may be stored in one memory 144, and the capabilities and/or preference list for the mobile element 102 in another memory 146. Of course, the memories 144, 146 are coupled to the processor 124 and may be integral with the memory 126. In any event, the information stored by the broadcaster 104 with respect to one or more mobile elements 102, their positions, and capabilities will allow businesses 109, 110 and broadcasters 104 alike to more carefully tailor the lists/preferences 128 and applications 130 offered to the public.

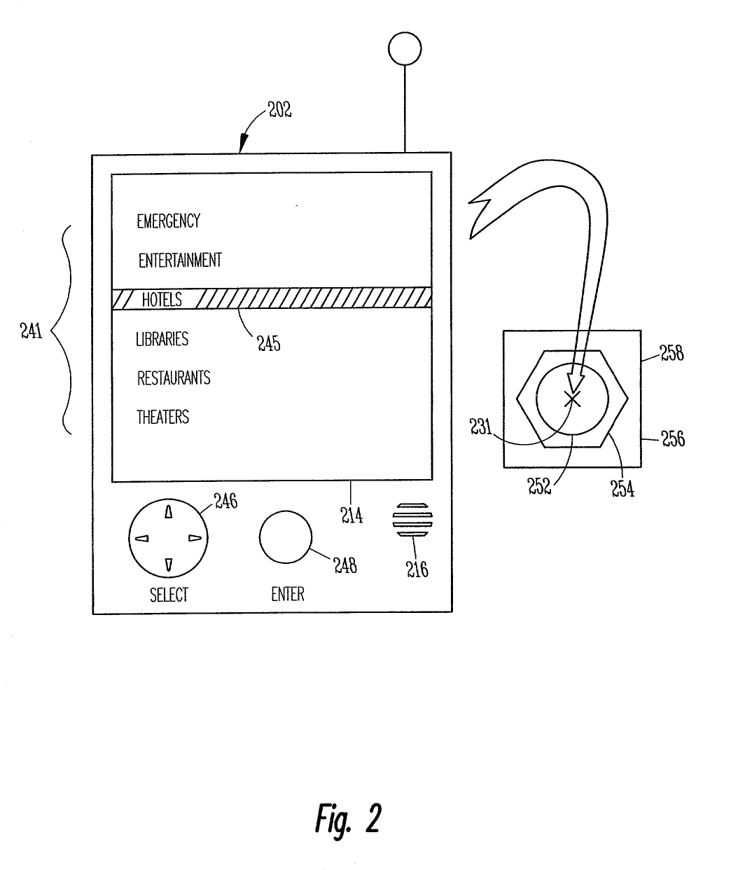

FIG. 2 is a block diagram representation of a mobile element according to an embodiment of the present invention. As mentioned above, the mobile element 202 may be equipped with a high-quality display 214 and an audio output device 216, such as one or more speakers. Thus, an exemplary selection list 241 of subjects for which file/preference information has been received from the broadcaster may be made available to the user via the display 214. The items in the list 241 may also be announced to the user via the audio output device 216. As shown in the figure, a selection 245 may be made by navigating within the collection 241 using a multi-axis manipulator 246, such as a joystick or gimbaled button, and a selector element 248, such as a push-button, for example. Of course, the multi-axis manipulator 246 and the selector element 248 can also be combined into a single selection device, as is well known to those skilled in the art.

As described previously, a position 231 is associated with the mobile element. This position 231 may be reported to either the mobile element 202 (for later transmission to the broadcaster 104), the broadcaster 104 (via the mobile element 202 or the network 106), or both. Of course, if the position 231 is maintained by the broadcaster 104 in a memory 144, there may be no need for the position 231 to be stored in the mobile element 102. The position may be obtained with relative precision from a global positioning system receiver communicatively coupled to the position monitoring module in the form of a set of geographic coordinates. The position may also be obtained from various other sources, in more precise forms, such as a street address entered by the user, or even in relatively crude forms, such as a zone identifier or radius 252 maintained by a cellular telephone service operator. The position may also be a cell 254, a street address, a map grid 256, and/or any other type of geometric figure or designation 258 which includes the basic position 231 of the mobile element.

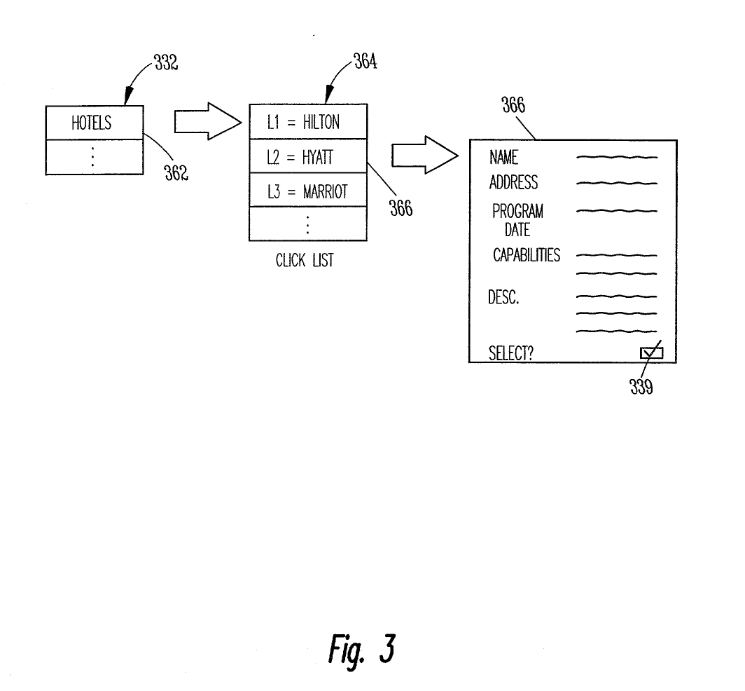

In any case, the collection of available information respecting services (i.e., reflecting a summary grouping of the received file lists—see FIG. 1, element 136) may be formatted as a high-level selection list 241 which includes a selected number of items determined by the position 231. Thus, the mobile element 202 may accept, or the broadcaster may deliver, lists of services which are related to the position 231 of the mobile element 202, as determined by the position monitoring module, or as reported to the broadcaster by the mobile element 202, or the network. Restricting the delivery of information in this fashion contributes to increased efficiency with respect to the use of available bandwidth. FIG. 3 is an exemplary tabular listing of various types of information which may be provided to a mobile element according to the present invention. Thus, for example, the business 109 (see FIG. 1) may be a hotel whose services are briefly described in one of the files 128 maintained by the broadcaster 104, including an associated application (e.g., file F2 and associated application APP22). Assuming that the services offered by the business 109 are related to one or more of the items in the list of preferences 332 maintained in the memory of the mobile element 102, such as the item 362 “HOTEL”, when the broadcaster determines that some relationship exists between the list of preferences 332 and the available files 128, the related files (e.g., F2) may be broadcast to the mobile element (or, as described above, all files 128 may be broadcast, with only the related files (e.g., F2) being accepted and retained by the mobile element). Then, the plurality of available services (see FIG. 1, items L1, L2 . . . LM) is typically formatted as a selection list, or “click” list.

In this exemplary illustration, a click list 364, including file data for the HILTON™ hotel, file data 366 for the HYATT™ hotel, and file data for the MARRIOT™ hotel may be displayed by the mobile element. After selecting the HYATT™ file data 366, the file data 366 is typically accessed by the mobile element 102. The file data 366 typically includes further identifying information regarding the business services or some other preference selected by the user, such as the name of the business, its physical address, email address, phone number, and some sort of detailed description which serve to distinguish the list 366 from those provided by other businesses. Some or all of the identifying information in the file data 366 may be displayed or announced to the user of the mobile element 102. The file data 366 may also contain administrative information, such as the latest application version (to determine whether an updated application download is necessary, or merely a data update), applicable network and/or zones, GPS coordinates of the business, minimum mobile element capabilities required to execute the associated application, etc. A selection 339 to download an associated application may occur automatically, such that the application associated with the selection 339 is downloaded at the same time the list is displayed or announced to the user of the mobile element. Downloading may also occur following a manual selection by the user of the mobile element. Execution of the associated application may then follow automatically, after a predetermined time, or as selected by the user.

Thus, referring now to FIGS. 1, 2, and 3, the invention may include a mobile element 102 having a position monitoring module 117 for monitoring a position 231 associated with the mobile element 102. The mobile element 102 typically also has a memory 111 including one or more service preferences 132, and one for more list files 136 received from a service broadcaster 104. The service broadcaster 104, in turn, usually includes one or more service preferences in the form of possible user preferences or business data files 128. All of the files 128 may be broadcast to the mobile element 102, and filtered by the module 137. Alternatively, only those files (i.e., a subset of all the files 128) which are related to the capabilities 140 of the mobile element 102 and/or the preferences 132 contained therein may be broadcast to the mobile element 102 by the broadcaster 104. In each case, however, the files 128 broadcast to the mobile element 102 may be sent to the mobile element if they comport with the position 231 of the mobile element 102. That is, the broadcaster 104 will typically not broadcast files 128 to the mobile element 102 which contain information about businesses located remotely from the position 231. The mobile element 102 may include a comparator module 137 communicatively coupled to the memory 111, the service preferences 132, and the received list files 136 so as to compare the service preferences 132 with those retained files 136 received by the mobile element 102 from the broadcaster 104. Finally, the mobile element 102 may also include a global positioning system receiver 118 communicatively coupled to the position monitoring module 117 so as to provide a refined indication of the position 231 of the mobile element 102.

As described above, the invention also includes a service broadcaster, which may have one or more memories 144, 146 for receiving a position and one or more service preferences associated with the mobile element, a plurality of available services retained in the memory including at least one service preference related to the service preferences of the mobile element and associated with the position of the mobile element), and an application associated with the service preference.

The service broadcaster may also include a memory for receiving a set of capabilities associated with the mobile element, such that the application associated with the related service preference is not downloaded to the mobile element if the set of capabilities associated with the mobile element is not in accordance with a set of application requirements associated with the application.

One of ordinary skill in the art will understand that the application execution system and apparatus of the present invention can be embodied in ways other than those which have been specifically illustrated, and thus, the invention is not to be so limited. The illustrations of an application execution system 100 and apparatus 102, 104, 202 are intended to provide a general understanding of the structure of the present invention, and are not intended to serve as a complete description of all the elements and features of application execution systems, apparatus, and software which might make use of the circuitry and structures described herein.

Devices which may include the novel application execution system and apparatus of the present invention include electronic circuitry used in high-speed computers, communication circuitry, modems, processor modules, embedded processors, and application-specific modules, including multilayer, multi-chip modules. Such application execution systems and apparatus may also be included as sub-components within a variety of electronic systems, such as televisions, cellular telephones, personal computers, personal radios, automobiles, aircraft, and others.

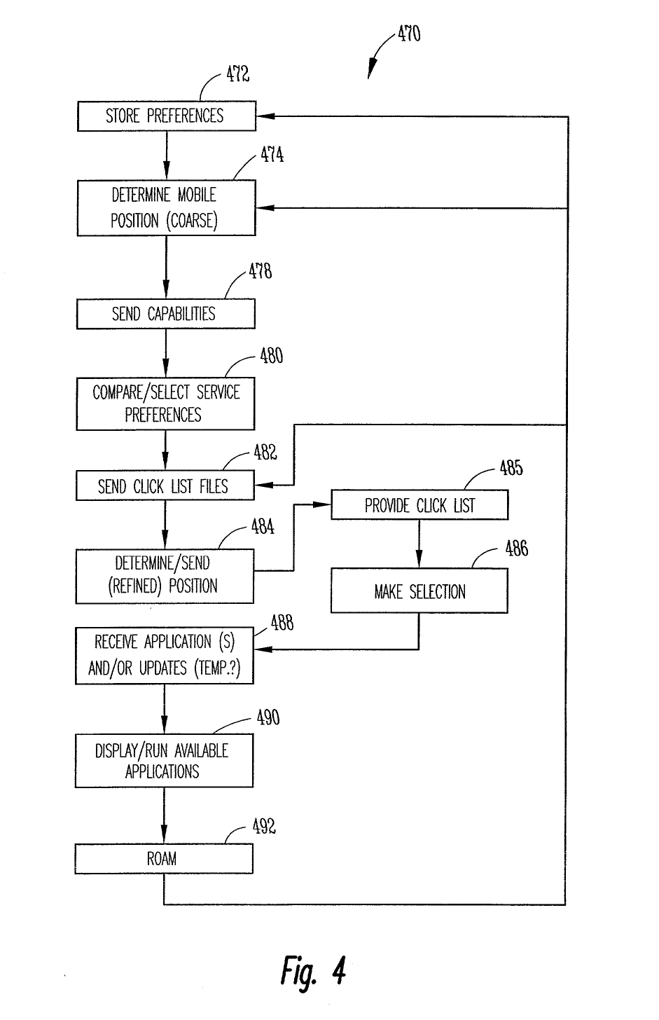

FIG. 4 is a flow chart illustrating an embodiment of a method for of executing an application according to the present invention. The method 470 begins at block 472 by storing a list or group of user service preferences in the mobile element as a profile associated with a particular user. Of course, multiple users may store individual profiles on a single mobile element. Further, a single user may store multiple profiles, such as a travel profile (including preferences such as drugstores, taxi services, hotels, movie theatres, etc.) and a work profile (including preferences such as parts suppliers, towing services, book stores, etc.).

The method continues with block 474 by determining the mobile element position, possibly in a coarse fashion, such as by obtaining telecommunications service operator zone identification information, which may be supplied to the broadcaster by way of a network. As noted above, other position determination methods and apparatus may be used, such as a GPS receiver located within the mobile element, triangulation initiated by the broadcaster, cell connection information (typically provided by a telecommunications service provider), etc.

The mobile element may then send a list of its capabilities to the service broadcaster in block 478, possibly as part of a cellular network registration procedure. Based on a comparison with the position information obtained in block 474, related business data files, including the information required to construct a click list, may be selected for broadcast to the mobile element in block 480.

As noted previously, the files can be pre-filtered (before broadcast) by the service broadcaster, according to received user service preferences. The files broadcast by the service broadcaster can also be post-filtered by the mobile element, which may compare the information in the received files with the service preferences contained in the mobile element, and discard files which do not match, or are not related, to the preferences. The list files are sent to the mobile element in block 482. The mobile element capabilities information may also be used to pre-filter files broadcast to the mobile element in block 482.

The capabilities list may also affect the application information which is associated with a particular item in the click list developed by the mobile element. For example, some items in the click list may be associated with extremely complex applications supported only by very sophisticated hardware within receiving mobile elements. These same items may also be associated with simple applications that can be downloaded as an alternative to the more complex applications (e.g., the file F2 may be associated with the complex application APP21, and the simpler application APP22, which requires much less memory to execute than does the application APP21), depending on the capabilities information which is received by the broadcaster, or maintained by the mobile element. Thus, the mobile element position, user preferences, and capabilities list may be used to make a comparison and selection of service preferences by the mobile element at block 480. The service broadcaster may also make the comparison and selection.

A refined version of the position information for the mobile element may be determined, either by the service broadcaster or the mobile element, in block 484. Thus, the initial group of list files may be delivered to the mobile element in block 482 based on a coarse position (e.g. telecommunications service provider zone information) determined in block 474. A refined position (e.g., GPS coordinates) may then be determined by the service broadcaster, another entity, or the mobile element (and sent to the service broadcaster) in block 484.

A click list is then developed from the received list files by the mobile element at block 485. The click list may be displayed to the user, announced to the user, or both. The click list is typically constructed in accordance with the mobile element position, user preferences, and may also be modified prior to display according to refined position information obtained at block 484.

After a particular item is selected from the click list in block 486, one or more applications associated with the selection are received for downloading by the mobile element in block 488. Those applications which require capabilities which exceed or do not match the capabilities of the mobile element will not be broadcast. The existence of cached applications and application date/version information delivered to the mobile element at block 482 may enable a determination that only an update of the application, and/or its data, should be broadcast to the mobile element. At this time, the application and/or its data may also be marked as temporary and/or prioritized, to enable its removal from the mobile element memory as needed. In addition, applications which are not executed within a certain amount of time may also be removed from the mobile element memory to increase efficient use of the memory.

Then, at block 490, one or more downloaded applications may be executed by the mobile element, while the mobile element continues to roam at block 492. The method may end at this point, continue with a revision of preferences at block 472, obtaining a new coarse position at block 474, or with the reception of additional click list information at block 482.

It should be noted that an embodiment of the invention may also include a computer readable medium (e.g., the memory 111) having program instructions stored thereon for implementing, when executed by a digital processing device (e.g., the processor 112), the method for executing an application described above. As described previously, the instructions may implement a method which includes determining the position of the mobile element and selecting a service preference associated with the application according to the position of the mobile element, as well as a service preference retained in the mobile element. The method may also include: broadcasting the associated service preference to the mobile element, requesting broadcast of the application, and broadcasting the application to the mobile element for downloading and execution. The method may further include sending a set of capabilities associated with the mobile element to a service broadcaster, and refraining from broadcasting the application to the mobile element if the set of capabilities associated with the mobile element is not in accordance with a set of application requirements associated with the application.

The system, apparatus, and method of the invention provide an efficient way to execute applications associated with services provided by various entities proximate to the physical location, or position of a mobile element. Available bandwidth is occupied with summary lists of information which may be pre-screened by the broadcaster, and, after selection by the user (or automatic selection according to user preferences), applications are sent to the mobile element. The invention also provides the capability to limit broadcasts to updates of applications and/or their associated data, as appropriate.

Although specific embodiments have been illustrated and described herein, those of ordinary skill in the art will appreciate that any arrangement which is calculated to achieve the same purpose may be substituted for the specific embodiments shown. This disclosure is intended to cover any and all adaptations or variations of the present invention. It is to be understood that the above description has been made in an illustrative fashion, and not a restrictive one. Combinations of the above embodiments, and other embodiments not specifically described herein will be apparent to those of skill in the art upon reviewing the above description. The scope of the invention includes any other applications in which the above structures and methods are used. The scope of the invention should be determined with reference to the appended claims, along with the full range of equivalents to which such claims are entitled

What is claimed is:

1. An application execution system, comprising:
a position monitoring module;
a mobile element associated with a position capable of being monitored by the position monitoring module, the mobile element having a memory including a set of user service preferences including a first service preference;
a service broadcaster capable of being communicatively coupled to the mobile element and broadcasting a second service preference to the mobile element; and
a comparator module communicatively coupled to the mobile element to compare the first and second service preferences.

2. The application execution system of claim 1, wherein the position monitoring module includes a software program.

3. The application execution system of claim 1, wherein the comparator module resides in the service broadcaster.

4. The application execution system of claim 1, further comprising: a global positioning system receiver communicatively coupled to the position monitoring module.

5. The application execution system of claim 1, wherein the mobile element includes a memory, and wherein the service broadcaster includes an application associated with the second service preference.

6. The application execution system of claim 5, wherein the application is downloaded to the memory when the first and second service preferences are determined to be related by the comparator module.

7. The application execution system of claim 6, wherein the mobile element is a personal internet client.

8. The application execution system of claim 1, wherein the mobile element is a cellular telephone.

9. The application execution system of claim 1, wherein the second service preference is a hotel list file.

10. The application execution system of claim 1, wherein a plurality of list files related to the set of user preferences is broadcast to the mobile element.

11. The application execution system of claim 10, wherein the plurality of list files is formatted as a selection list.

12. The application execution system of claim 11, wherein the selection list includes a selected number of items determined by the position.

13. A mobile element, comprising:
a position monitoring module capable of monitoring a position associated with the mobile element;
a first memory including a first service preference, the memory capable of receiving a second service preference determined by the position; and
a comparator module communicatively coupled to the memory to compare the first and second service preferences.

14. The mobile element of claim 13, further comprising: a global positioning system receiver communicatively coupled to the position monitoring module.

15. The mobile element of claim 13, wherein the service broadcaster includes an application associated with the second service preference, and wherein the application is downloaded to the memory when the first and second service preferences are determined to be related by the comparator module.

16. A apparatus, comprising:
a processor;
a memory coupled to the processor for receiving a position and a first service preference associated with a mobile element;
a memory coupled to the processor including a a second service preference associated with the position; and
an application associated with the second service preference.

17. The apparatus of claim 16, wherein the application is downloaded to the mobile element when the second service preference is related to a first service preference stored in the mobile element.

18. The apparatus of claim 16, further comprising:
a memory for receiving a set of capabilities associated with the mobile element.

19. The apparatus of claim 18, wherein the application is not downloaded to the mobile element if the set of capabilities associated with the mobile element is not in accordance with a set of application requirements associated with the application.

20. A method of executing an application, comprising:
determining a position of a mobile element; and
selecting a second service preference associated with the application according to the position and a first service preference retained in the mobile element.

21. The method of claim 20, further including:
broadcasting the second service preference to the mobile element;
requesting broadcast of the application; and
broadcasting the application to the mobile element for downloading and execution by the mobile element.

22. The method of claim 20, further including:
storing the first service preference in the mobile element.

23. The method of claim 20, further including:
sending a set of capabilities associated with the mobile element to a service broadcaster; and
refraining from broadcasting the application to the mobile element if the set of capabilities associated with the mobile element is not in accordance with a set of application requirements associated with the application.

24. The method of claim 20, wherein the second service preference is a hotel list file.

25. A computer readable medium having program instructions stored thereon for implementing, when executed by a digital processing device, a method for executing an application, said method comprising:
determining a position of a mobile element; and
selecting a second service preference associated with the application according to the position and a first service preference retained in the mobile element.

26. The computer readable medium of claim 25, wherein the method further comprises:
broadcasting the second service preference to the mobile element;
requesting broadcast of the application; and
broadcasting the application to the mobile element for downloading and execution by the mobile element.

27. The computer readable medium of claim 25, wherein the method further comprises:
sending a set of capabilities associated with the mobile element to a service broadcaster; and
refraining from broadcasting the application to the mobile element if the set of capabilities associated with the mobile element is not in accordance with a set of application requirements associated with the application.
